(19) United States
(12) Patent Application Publication
(10) Pub. No.: US 2010/0175902 A1
(43) Pub. Date: Jul. 15, 2010

(54) METHOD FOR ADJUSTING AN ELECTRIC POWER TOOL

(75) Inventors: Marcin Rejman, Waiblingen (DE); Wolf Matthias, Stuttgart (DE); Florian Schmehl, Renchen-Ulm (DE); Thomas Heinrich, Leinfelden (DE); Simeon Staebler, Leinfelden-Echterdingen (DE); Rainer Glauning, Leinfelden-Echterdingen (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/683,889

(22) Filed: Jan. 7, 2010

(30) Foreign Application Priority Data
Jan. 9, 2009 (DE) 10 2009 000 129.8

(51) Int. Cl. B25F 5/00; B23Q 5/00

(52) U.S. Cl. 173/1; 173/2

(57) ABSTRACT

The present invention relates to a method, with which an electric power tool is operated, which comprises a drive motor, a drive unit as well as a tool, the tool being operated by means of the drive unit and the drive motor. Said tool can be operated in at least two operating modes, said operating modes varying due to the properties of the drive motor and/or the drive unit. The setting of at least one of the two operating modes occurs automatically. The present invention furthermore relates to an electric power tool, which particularly can be operated with the one method according to the invention, having a drive motor, a drive unit as well as a tool, said tool being operable in at least two operating modes by means of the drive unit and the drive motor. The operating modes vary due to the properties of the drive motor and/or the drive unit. Said power tool comprises a detection means, with which the necessity for switching the operating mode can be ascertained and is characterized by further comprising a control means, with which one of the two operating modes can be automatically adjusted.

This application claims benefit of Serial No. 10 2009 000 129.8, filed 9 Jan. 2009 in Germany and which application is incorporated herein by reference. To the extent appropriate, a claim of priority is made to the above disclosed application.

### BACKGROUND

The present invention relates to a method for operating an electric power tool, which comprises a drive motor, a drive unit as well as a tool, wherein the tool is operated by means of the drive unit and the drive motor, wherein the tool can be operated in at least two operating modes, wherein the operating modes vary due to the properties of the drive motor and/or the drive unit. The present invention further relates to an electric power tool, which is operated with the method according to the invention.

The term “operating mode of an electric power tool” is used below as a synonym for the operating mode, with which the tool of the electric power tool is operated.

Electric power tools, respectively their tool, can often be operated in a plurality of different operating modes. For example, the speed, respectively the RPM range, in which an electric power tool is operated, is adjustable; or a clockwise and anticlockwise rotation, respectively an advancing and reversing operation, of an electric power tool is adjustable. The chisel function or a hammering mechanism of a rotary hammer may also be on/off switchable.

Selecting the correct operating mode is often difficult for inexperienced users. They are, for example, not conscious of the fact that drilling almost always requires a clockwise rotation of the power tool or that the previously selected speed is too high or too low for the present application. Work with the power tool is therefore in most cases initially begun with the previously selected operating mode. The operating mode is only then reset when the result is either absent or unsatisfactory. Even when the operating mode is reset, the operator often still selects the wrong mode. Indication of the operating mode using illuminated symbols, for example for the direction of movement of the electric power tool, does not help the inexperienced user.

Not only can the electric power tool be unnecessarily stressed as a result of a faulty setting of the electric power tool, but such a faulty setting can also cause the workpiece to be damaged. Moreover, an increased risk of injury arises for the user through the improper use of the electric power tool.

It is therefore the aim of the present invention to develop a method for operating an electric power tool, whereby faulty settings of the operating mode of the electric power tool are avoided and whereby the use of the electric power tool is simplified particularly for an inexperienced user.

### SUMMARY

The aim of the invention is met by a method, wherein an electric power tool is operated, which comprises a drive motor, a drive unit as well as a tool, wherein the tool is operated by means of the drive unit and the drive motor, wherein the tool can be operated in at least two operating modes, wherein the operating modes vary due to the properties of the drive motor and/or the drive unit, wherein the setting of one of the two operating modes automatically occurs.

It is therefore possible according to the invention for the setting of at least one operating mode of the power tool to be done automatically. The setting of this automatically adjustable operating mode therefore occurs without the operator having to select it.

An operating mode in the sense of the invention is a setting and/or property of the drive motor and/or the drive unit, whereby the tool of the electric power tool can be operated in a characteristic fashion. Examples for operating modes are: clockwise rotation, anticlockwise rotation, advancing operation, reversing operation, RPM, torque, speed, performance parameters; drilling, hammering and chiseling mode, adjustment of a pendulum action and others.

The operating mode of the tool of the electric power tool, which is automatically set, is preferably a basic setting, a standard setting or a preferable setting of the electric power tool. This setting of the electric power tool most preferably corresponds to a frequent application for the tool.

The operator of the power tool can proceed from a basic setting as a result of the automatic setting of the operating mode. Provided this basic setting corresponds to a frequent application for the tool, the power tool is already correctly set for that portion of the applications which most frequently occurs. This is done without the operator having to know about the setting in detail or having to carry out the adjustment himself.

Even if an additional adjustment of the setting, respectively correction of the operating mode, is necessary, the automatically adjustable operating mode can be selected in such a way that damage to the workpiece or a risk of injury to the operator is eliminated as much as possible without the additional adjustment of the setting, respectively correction of the operating mode.

The automatically adjustable operating mode is preferably set as a function of the properties of the drive motor, the drive unit, the target group of operators, the type of electric power tool and/or the current operating mode.

The properties of the drive motor are in doing so for example: maximum, minimum and/or nominal parameters (in particular for operating variables such as current and voltage), performance parameters, design, RPM, speed, rotational direction and/or torque etc. of the drive motor.

A drive unit comprises electrical as well as mechanical or other drive components. Examples for properties of the drive unit are: an activated or deactivated pendulum action of a jig saw, an activated or deactivated chisel function, respectively rotation-stop, or an activated or deactivated hammering mechanism of a rotary hammer, a seating torque or an overload torque or others.

A relevant property for a target group is, for example, the difference between an electric power tool for a professional operator or for an amateur. Provision can, for example, be made in a preferred embodiment for the automatic adjustability of the operating mode to be deactivated by the professional operator.

It is furthermore preferred to distinguish between the types of electric power tools because a practical setting for a drill/driver is not practical for a rotary hammer; or a setting for a jig saw must not also be practical for a circular saw.

Furthermore, the currently set operating mode is also taken into account for the selection of the automatically adjusted operating mode. This is the case because the standard setting for the operating mode can, for example, already be set. Or the preferred standard setting of the operating mode cannot be practical due to another currently set operating mode of the electric power tool. Then, for example, permitting anticlockwise rotation is not practical when the hammering mechanism of a rotary hammer is activated. Preferably another preferred operating mode is automatically adjusted in such a case.

In addition the operating modes are furthermore also preferably at least partially manually adjustable. The operator can thereby correct or completely change the automatically adjusted operating mode depending on his current application.

In a preferred embodiment, the automatically adjustable operating mode is adjusted when the electric power tool is being switched on and/or a job has been completed and/or the electric power tool is being placed in a storage case and/or said power tool is being manually switched to another operating mode.

In this way the operator is aided in or even spared readjusting the operating mode when switching on the electric power tool and preferably when starting each new job. He can then proceed from a standard setting of the power tool after the operating mode has been automatically adjusted. Particularly the manual switching of the power tool by the operator to a new operating mode, in which the previously adjusted operating mode is no longer practical, is thereby considerably simplified. If, for example, the operator switches on the chisel function of a rotary hammer, an anticlockwise rotation is no longer practical, and the power tool can automatically be adjusted to the clockwise rotation. In so doing, the electric power tool is also automatically transferred to a basic, respectively standard, setting when the operating modes are being manually switched. The probability of a faulty setting is thereby decreased.

Because the automatically adjusted operating mode preferably corresponds to the most prevalent application, the frequency of faulty settings due to a wrong tool adjustment made by the operator, which can lead to damage to a workpiece or even to its destruction or to an injury, is very small. The operation of the power tool is therefore considerably safer and simplified for the operator.

The aim of the invention is furthermore met by means of an electric power tool, which can particularly be operated with the method according to the invention, having a drive motor, a drive unit as well as a tool. Said tool can thereby be operated by means of the drive unit and the drive motor in at least two operating modes, said operating modes varying due to the properties of the drive motor and/or the drive unit. The electric power tool thereby comprises a detection means, with which the necessity of switching the operating mode can be ascertained. Said power tool also thereby comprises a control means, with which at least one of the two operating modes can be automatically adjusted.

If the necessity for switching the operating mode is therefore ascertained by the detection means, the electric power tool according to the invention is automatically adjusted to an operating mode by the control means, which is preferably a standard setting, a basic setting or a preferred setting of the electric power tool. The electric power tool is therefore easier to use for an inexperienced operator, and the frequency of a faulty setting of the power tool is decreased. An overloading of the electric power tool and/or damage to or even the destruction of a workpiece being machined by the electric power tool due to a faulty setting is therefore frequently avoided.

The detection means is preferably an electrical, magnetic, optical or mechanical detection means, in particular an ammeter, voltmeter, timer, revolution counter, torquemeter, switch, sensor or receiver. Properties and/or settings of the electric power tool, in particular of its drive motor and/or its drive unit, can therefore be ascertained with the detection means.

A plurality of detection means are likewise preferably provided in the electric power tool. With the detection means or as the case may be plurality of detection means, the switching-on of the electric power tool, the completion of an application, the switching-off of the electric power tool and/or the switching of the electric power tool to another operating mode can therefore be detected.

The detection means is a component of the electric power tool and is preferably disposed in and/or on and/or outside the electric power tool.

With the control means, the automatic adjustment of the operating mode is electrically and/or mechanically possible, preferably electrically.

An electric power tool according to the invention is preferably a hand-held electric power tool, in particular a screwdriver, a saw, a router, a rotary hammer, shears or another electric power tool.

### BRIEF DESCRIPTION OF THE DRAWINGS

The invention is described below with the aid of a figure. The figure is merely an example and does not limit the general inventive idea.

FIG. 1 shows schematically an electric power tool according to the invention.

### DETAILED DESCRIPTION

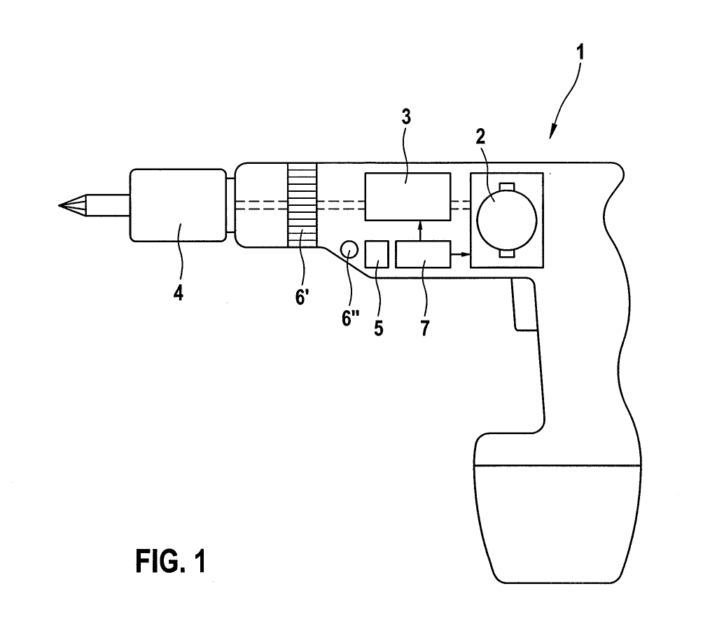

FIG. 1 schematically shows an electric power tool according to the invention and namely a screwdriver 1 in the example of embodiment depicted here. The terms electric power tool 1 and screwdriver are therefore used synonymously below. The screwdriver 1 comprises a drive motor 2, a drive unit 3 as well as a tool 4, the tool 4 being driven by the drive unit 3 and the drive motor 2. The electric power tool 1 comprises a detection means 5 for ascertaining the necessity for switching the operating mode. In the event that the necessity for switching said mode is ascertained by the detection means 5, this switching automatically occurs via the control means 7 of the electric power tool 1.

In the depicted form of embodiment, the screwdriver 1 is provided with a first as well as a second operating control 6′, 6″. The RPM range can thereby be manually adjusted using the first operating control 6′ and the rotational direction can be manually switched from clockwise rotation to anticlockwise rotation of the electric power tool 1 and back using the second operating control 6″. The tool 4 of the screwdriver 1 can therefore at least be switched to the operating modes “clockwise rotation” or anticlockwise rotation” and to variedly high speeds. In so doing, these operating modes can also be adjusted in combination with each other.

In order to determine whether the necessity for switching the screwdriver 1 to an automatically adjustable operating mode exists, provision can be made for the detection means 5 to be, for example, a timer, a revolution counter and/or a torquemeter. Furthermore, the operating controls 6′, 6″ can also serve as detection means 5.

A preferred setting for the operating mode of the tool 4 of a screwdriver 1 is the combination of the operating modes “clockwise rotation” and “high speed”, in particular when drilling or when driving a screw. This is the case because these operating modes probably correspond to the coming application. If the detection means 5 detects the switching-on of the screwdriver 1, the completion of an application and/or the placing of the screwdriver 1 into a storage case, the screwdriver 1 is automatically adjusted to the operating modes “clockwise rotation” and “high speed” according to the invention, provided it has not already been adjusted to these operating modes.

Furthermore, an automatic setting of an operating mode can also occur when the screwdriver 1 is manually switched by the operator using the operating controls 6′, 6″. If the electric power tool 1 is, for example, switched from “anticlockwise rotation” to “clockwise rotation”, the adjustment to the operating mode “high speed” preferably occurs automatically. In this case the second operating control 6″, with which the manual switching from the anticlockwise to the clockwise rotation is carried out, is simultaneously a detection means 5.

Or in the case of a screwdriver 1, in which the operating modes can be switched between “screw-driving” and “drilling”, i.e. between a torque limit and no torque limit, an additional automatic adjustment to the operating mode “clockwise rotation” is practical and if need be additionally to the operating mode “high speed” if the operating mode “drilling” is adjusted. This is the case because a drilling operation is probably intended. In this operating mode, the operator preferably should be able to manually switch back to “anticlockwise rotation”. This is the case because a torque limit can be undesirable when removing screws.

It is also furthermore preferred in the case of screwdrivers 1 for the operating mode “high speed” to automatically adjust when adjusting to “anticlockwise rotation” for removing screws. Especially in the case of removing screws, a large amount of torque is for the most part not required, and the operating speed is of prime importance.

Or an automatic adjustment to the operating mode occurs if a screw was previously removed in an anticlockwise direction.

In addition preferably further properties of the drive motor 2 beside the rotational direction and the selection of the speed, respectively the RPM range, wherein an electric power tool 1 is operated, are automatically adjusted, in particular the torque limit previously mentioned above. Furthermore, standard power settings are preferably additionally adjusted so that, for example, no excessively large adjusted torque of the drive motor 2 leads to a rapid start-up of the tool 4 and as the case may be destroys the workpiece during actuation of the electric power tool 1.

In doing so the switching of operating modes preferably occurs after completion of the application or after an extended non-use of the electric power tool 1.

It is additionally advantageous in the case of rotating electric power tools 1 such as, for example, a screwdriver 1 or a rotary hammer to automatically adjust the rotational direction of the drive motor 2 as a function of current properties and/or settings of the drive motor 2 and/or the drive unit 3.

An embodiment of an electric power tool 1 is furthermore conceivable, wherein a detection means 5 is disposed on an exterior side of the housing, in particular as a switch or lever, with which the operator can activate the automatic setting of the operating mode. The detection means 5 positioned on the outside of the housing of the electric power tool 1 allows the operator to shift the electric power tool 1 to the automatically adjusted operating mode. The operator therefore does not have to actively change the properties of the electric power tool 1 himself. On the contrary, the power tool 1 itself automatically carries out the necessary changes for adjusting the basic, respectively standard, setting if the operator actuates the detection means positioned on the outside of the housing. Especially the inexperienced operator can than proceed from this basic setting and if need be change it in accordance with his application. The operation of the electric power tool 1 is therefore considerably simplified particularly for the inexperienced operator.

The automatic setting of the operating mode can also be activated in a variety of other ways. If an electric power tool 1 is put into a storage case after an application has been completed, an adjustment to the automatically adjustable operating mode is likewise practical.

Said adjustment can, for example, occur via a means, with which a detection means is actuated, disposed in the storage case. A magnet, switch, lever, a contour or a transponder for actuating the detection means 5 and for activating the adjustment to the automatically adjusted operating mode may, for example, be used as such a means.

An electric power tool 1 can advantageously comprise an energy storage unit, for example a battery, so that the automatic setting of the operating mode can occur using the energy storage unit when switching off the electric power tool 1.

A data memory can also be alternately or additionally provided so that the current operating mode and/or the necessity for switching the operating mode can be deposited in the data memory. A corresponding adjustment can thus occur immediately after switching on the power tool.

Further examples for a preferred automatically adjustable operating mode, respectively the switching of a tool of other electric power tools 1, are stated below.

It is advantageous in the case of a jig saw to switch the pendulum action on or off and to adjust the RPM range.

In the case of a rotary hammer, the chisel function, respectively the rotation-stop and/or the hammering mode, is advantageously automatically switched on or off.

Furthermore when turning on the hammering mechanism of a rotary hammer, the operating mode is automatically changed to “clockwise rotation”.

Conversely the hammering mechanism is preferably deactivated when switching the rotary hammer from the operating mode “clockwise rotation” to the operating mode “anticlockwise rotation”. Said deactivation preferably occurs because obviously a screwing operation is about to happen.

It is likewise preferably possible for a manual shift to an operating mode to be prevented because, for example, the allowance for a chisel function is not technically practical when the operating mode anticlockwise rotation is switched on.

The usability of the method according to the invention is however not limited to the electric power tools 1 mentioned in the examples. On the contrary, the method can also be used with other electric power tools 1, in which at least one of a plurality of operating modes is preferred. Furthermore, the usability of the method according to the invention is also not limited to the operating modes mentioned in the examples.

1. Method, with which an electric power tool is operated, which comprises a drive motor, a drive unit as well as a tool, the tool being operated by means of the drive unit and the drive motor, wherein said tool can be operated in at least two operating modes, the operating modes varying due to the properties of the drive motor and/or the drive unit, wherein the setting of at least one of the two operating modes automatically occurs.

2. The method according to claim 1, wherein the automatically adjustable operating mode is a basic setting, a standard setting or a preferred setting of the electric power tool.

3. The method according to claim 1, wherein the automatically adjustable operating mode is set as a function of the properties of the drive motor, the drive unit, the target group of operators, the type of electric power tool and/or the current operating mode.

4. The method according to claim 1, wherein the necessity for switching the operating mode to the automatically adjustable operating mode is ascertained with a detection means.

5. The method according to claim 1, wherein the operating modes are also additionally at least partially manually adjustable.

6. The method according to claim 1, wherein the automatically adjustable operating mode is set when switching on the electric power tool and/or after completion of an application and/or when placing the electric power tool in a storage case and/or when switching to another operating mode.

7. The method according to claim 1, wherein the switching to the automatically adjustable operating mode occurs electrically and/or mechanically, preferably electrically.

8. Electric power tool, which can particularly be operated with a method according to claim 1, having a drive motor, a drive unit as well as a tool, said tool being operable by means of the drive unit and the drive motor in at least two operating modes, said operating modes varying due to the properties of the drive motor and/or the drive unit, wherein said power tool comprises a detection means, with which the necessity for switching the operating mode can be ascertained, and in that said power tool comprises a control means, with which at least one of the two operating modes can be automatically adjusted.

9. Electric power tool according to claim 8, wherein there is an electrical, magnetic, optical or mechanical detection means, in particular an ammeter, voltmeter, timer, revolution counter, torque meter, switch, sensor or receiver.

10. Electric power tool according to claim 8, wherein a plurality of detection means is provided.

11. Electric power tool according to claim 8, wherein the detection means is disposed in and/or on and/or outside the electric power tool.

12. Electric power tool according to claim 8, wherein the automatic adjustment of the operating mode by the control means is electrically and/or mechanically possible, preferably electrically.

13. Electric power tool according to claim 8, wherein it is an electric power tool, in particular a screwdriver, a saw, a router, a rotary hammer or a shears.
